(19) United States
(12) Patent Application Publication
(10) Pub. No.: US 2014/0292581 A1
(43) Pub. Date: Oct. 2, 2014

(54) Method and System for Determining Locations of Smartkeys

(71) Applicant: MITSUBISHI ELECTRIC RESEARCH LABORATORIES, INC., Cambridge, MA (US)

(72) Inventors: Philip Orlik, Cambridge, MA (US); Santosh Seran, Parsippany, NJ (US)

(73) Assignee: Mitsubishi Electric Research Laboratories, Inc., Cambridge, MA (US)

(21) Appl. No.: 13/851,170

(22) Filed: Mar. 27, 2013

(51) Int. Cl. G01S 3/14

(52) U.S. Cl. CPC G01S 3/14
USPC 342/417

(57) ABSTRACT

A location of a smartkey is determined by first determining coordinates of a set of candidate vertices of an array of receive antennas at a receiver based on maximal magnetic field voltages in the receive antennas due transmitting a radio signal (RF) by the smartkey. A set of candidate locations of the transmitter is determined based on the coordinate of the set of vertices. A set of final candidate locations is determined based on a predetermined threshold of the voltages. The final candidate locations are then combined to determine the location of the smartkey.

### FIELD OF THE INVENTION

This invention relates generally to wireless communication, and more particularly to smartkey systems.

### BACKGROUND OF THE INVENTION

Smartkey systems can be used for electronic access and authorization for entry. For example, a smartkey can be used to lock, lock, or start a vehicle, or to activate other operations. A radio signal emitted by the key is received by antenna elements arranged on the vehicle, see U.S. Publication 20080048846, Usually, a smartkey system includes a transmitter, a receiver, and a control unit connected to antennas of the receiver responsive to the radio signals emitted by the transmitter.

Typical smartkey systems use loop antennas or coils and a low frequency (100-130 kHz) radio frequency (RF), see U.S. Publication 20110248819. The systems rely on one or more multiple receiver elements located or embedded within the vehicle body to provide radio signal coverage. The range depends on the signal strength.

### SUMMARY OF THE INVENTION

The present invention provides a method and system for determining the location of a smartkey using voltages induced in an array of receive antennas and matching these to an approximation of the same voltages.

Specifically, a location of a smartkey is determined by first determining coordinates of a set of candidate vertices of an array of receive antennas at a receiver based on maximal magnetic field voltages in the receive antennas due transmitting a radio signal (RF) by the smartkey.

A set of candidate locations of the transmitter is determined based on the coordinate of the set of vertices. A set of final candidate locations is determined based on a predetermined threshold of the voltages. The final candidate locations are then combined to determine the location of the smartkey.

### BRIEF DESCRIPTION OF THE DRAWINGS

FIG. 1 is a schematic of a single loop antenna for a smartkey according to embodiments of the invention;

FIG. 2 is a schematic of a multi-loop antenna for a receiver according to embodiments of the invention;

FIG. 3 is a schematic of an operation environment of a smartkey system according to embodiments of the invention; and

FIG. 4 is a block diagram of a method for determining a location of a smartkey according to embodiments of the invention.

### DETAILED DESCRIPTION OF THE PREFERRED EMBODIMENT

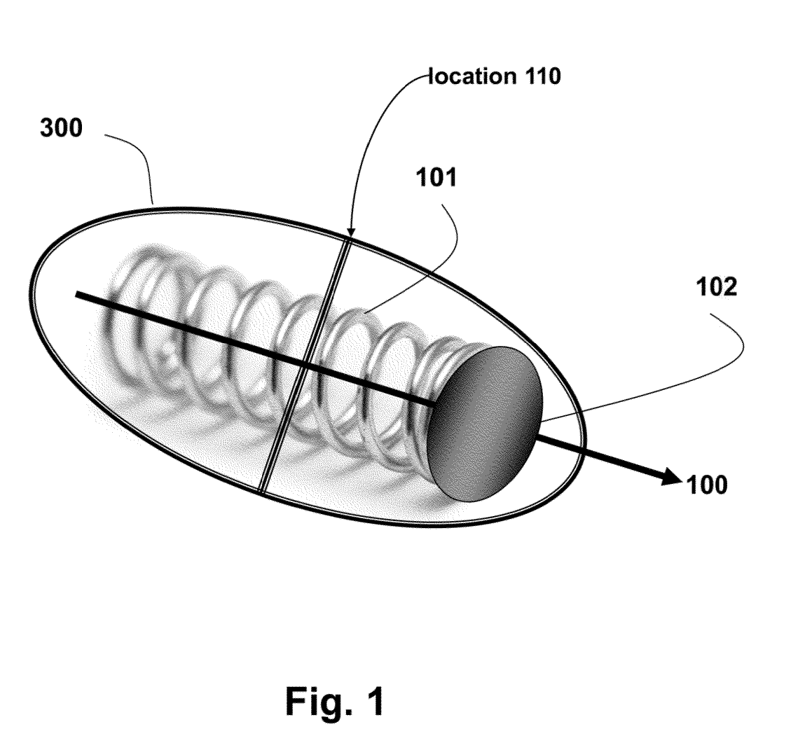

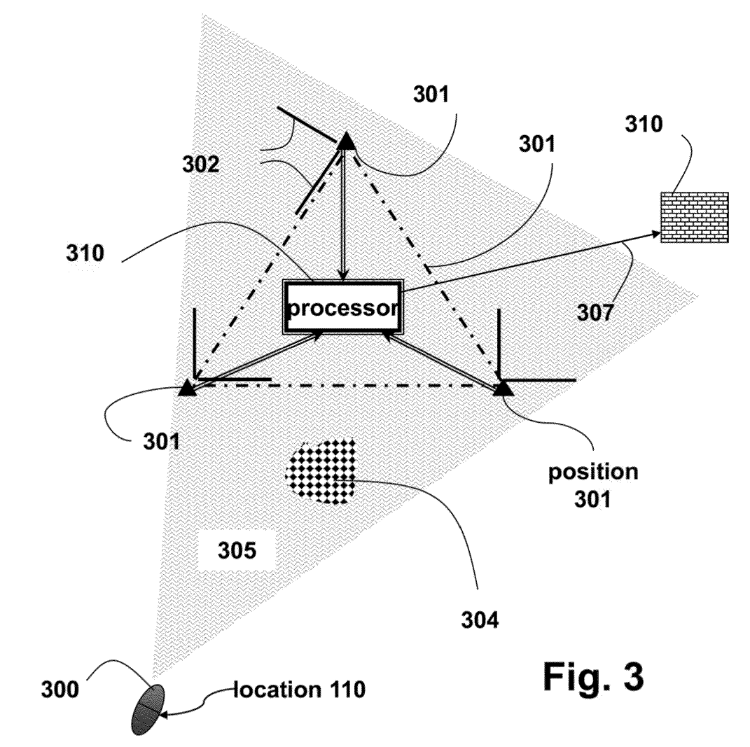

FIG. 1 shows a smartkey 300 used by embodiments of our invention for a smartkey system. A transmitter includes a single coil or loop antenna 101, i.e., a directional antenna, that can emit a magnetic field (radio signal) oriented along an axis 100 normal to the winding of the coil when the button 102 is pushed. Thus, only the magnetic field components that align along the direction of the normal are transmitted. It is desired to determine the location 110 of the transmitter, see FIG. 3. In one embodiment, the smartkey is conventional, e.g., a Mitsubishi FastKey. It is understood that the locations and positions described herein are relative.

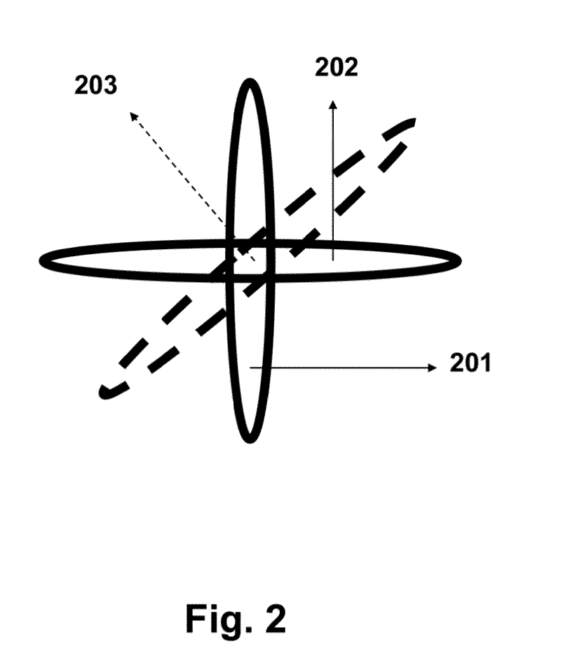

FIG. 2 schematically shows receiver antenna elements for the smartkey system with two orthogonal loops 201-202. Each antenna can sense a magnetic field intensity, and a direction of the field lines. A third coil 203 orthogonal to the other two coils increases the accuracy of the sensed. direction.

FIG. 3 shows an environment in which the smartkey system according to embodiments of our invention can operate. The system includes the smartkey 300, at some unknown location, with the transmitter and the single loop antenna. The antenna emits a radio frequency (RF) signal (LF) 305. The signal has a relatively low frequency, e.g., in a range of 100 to 200 kHz.

A receiver of the LF signal is an array of antennas 301. Each antenna includes two or more loops orthogonal 302 to each other as shown in FIG. 2. The elements can be arranged in an arbitrary geometry, although empirical measurements indicate that the triangular configuration provides better performance than other geometries. The deployment of the elements in a vehicle is simplified with triangular arrangement, e.g., two antenna elements can be placed in door handles, side view mirrors, or passenger head rests, and the third element can be placed in the vehicle roof or in the dome light housing. Thus, a reasonable arrangement of the antennas in the vehicle forms a triangular configuration. In any case, a 3D geometry of the configuration of the array of antennas is known.

The transmitter and receiver coils can be made resonant by adding a capacitance in parallel with coil. This reduces the effects of noise and obstacles in the environment where the smartkey system is used. The resonant frequencies of the transmitter and receiver coils are the same, and both frequencies are in the LF range specified above. The receiver coils are unloaded to increase the output voltage magnitude of the magnetic field) of the RF field.

The magnetic field 305 around the transmitter coil is H(r), where r 304 is a coordinate in the field. The field at position, H(r), can be an analytical approximation based on near field propagation characteristics of the transmitter. Alternatively, the field is obtained from measurements in the radiated field 305. If the measurements are carried out near the receive array and the vehicle, then the representation of the field is more accurate. In either case, the approximated or measured field H(r) is stored in a memory for uniform discrete spatial intervals. The size of the interval controls the accuracy of the spatial resolution.

When the transmitter coil is energized by pushing the button 102, the magnetic field of the transmitter is sensed at the vertices of the triangle using the orthogonal coil configuration shown in FIG. 2.

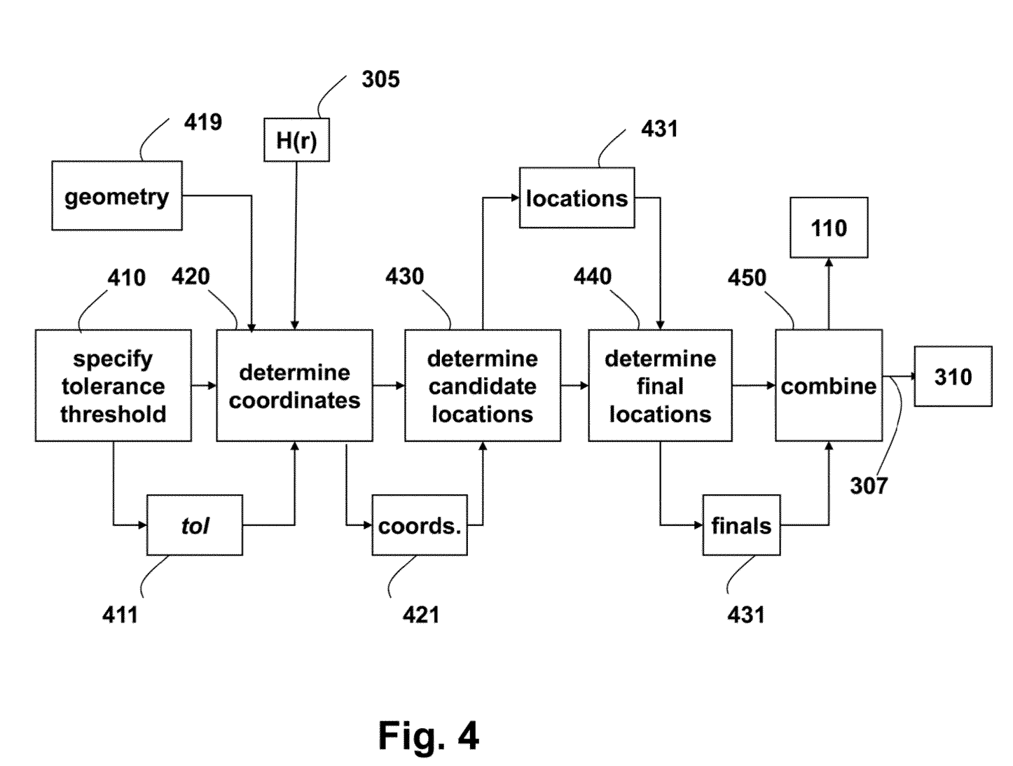

As shown in FIG. 4, a relative arrangement of the magnetic field 305 with respect to the antenna array 301 is determined according to the following method steps. The method steps can be performed in a processor 310 connected to a memory and input/output interfaces. The memory stores the approximate field values, and the input interfaces are connected to the antennas. The output interfaces can supply control signals 307 to perform the desired functions of a components or device 310, e.g., open door, turn on lights, access a computer, etc., and supply the coordinates of the location of the smartkey with respect to the vehicle. The control signal can be based on the location, e.g., the user of the smartkey is inside, in front, behind, or besides the vehicle.

A threshold or tolerance parameter To is specified 410. The geometry 419 of the antenna array is known, and can be stored in the memory of the processor, i.e., the relative 3D positions. A set of candidate coordinates 421 of vertices or antenna array element with a maximal magnetic field voltage, Max₁. The candidate set of N coordinates rᵢ 421 is determined 420, such that Max₁−Tol <|H(r)|<Max₁+Tol. The coordinates are relative to each other based on the array geometry.

All coordinates that satisfy these inequalities are potential positions of the array elements that sensed the maximal magnetic field. In general, there are many such positions, because only the magnitude of the magnetic field voltage is considered.

For each of the N candidates there are at least two possible orientations of the sensing triangle that can be used to further reduce the size of the set of candidate transmitter locations N.

For the known geometry 419 of the antenna array, specifically, the relative, distances between the vertices. The method determines 430 |H(rᵢ+r_{d})|, where rᵢ is one of a candidate locations 431, and r_{d} is a coordinate vector that when added to rᵢ yields the position of any of the other antenna array vertices.

To determine which of the candidate transmitter locations to process further, the method checks 440 to see if the measured value of the magnetic field magnitude at the other array vertex is within the range |H(rᵢ+r_{d})|+/−Tol, where +/− indicates plus or minus. If the measured magnetic field at the other vertices matches, up to the tolerance Tol, the expected value, given the approximated field H field, corresponds to the location of the transmitter, for known coordinate system transformations.

The above processing is done for all candidate locations rᵢ, for i=1, 2, . . . , N. to produce a final set of candidate locations 441. Due to noise and environmental disturbances, a single location is difficult to determine. Therefore, a combination 450 of the final locations can yield an estimate of the location 110 of the transmitter. The combination can be based on some statistical measure, e.g., the average, mean, maximum, and the like.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of (he invention.

We claim:

1. A method for determining a location of a smartkey, comprising the steps:
determining coordinates of a set of candidate vertices of an array of receive antennas at a receiver based on maximal magnetic field voltages in the receive antennas due transmitting a radio signal (RF) by the smartkey;
determining a set of candidate locations of the transmitter based on the coordinate of the set of vertices;
determining a set of final candidate locations based on a predetermined threshold of the voltages; and
combining the final candidate locations to determine the location of the smartkey, wherein the steps are performed in a processor.

2. The method of claim 1, wherein a transmit antenna of the smartkey is directional.

3. The method of claim 1, wherein the frequency is about less than 200 kHz.

4. The method of claim 1, wherein a three-dimensional geometry of the array of antennas is known at the receiver.

5. The method of claim 1, wherein the array of antennas is arranged in a vehicle.

6. The method. of claim 4, wherein the geometry is triangular.

7. The method of claim 2, wherein all the antennas are resonant with each other.

8. The method of claim 2, wherein the transmit antenna is a coil with a capacitance in parallel with the coil.

9. The method of claim of claim 1, further comprising:
generating a control signal by the receiver is based on the location.

10. The method of claim 1, wherein the determining of the coordinates is based on the tolerance.

11. The method of claim 5, wherein the set of candidate locations is based on the triangular geometry.

12. The method of claim 1, wherein the combining is based on an average of the locations.

13. A system for determining a location of a smartkey, comprising:
a receiver including an array of receive antennas; and
a processor configured to determine coordinates of a set of candidate vertices of an array of receive antennas at the receiver based on maximal magnetic field voltages in the receive antennas due transmitting a radio signal (RF) by the smartkey, and to determine a set of candidate location of the transmitter based on the coordinate of the set of vertices; and to determine a set of final candidate a locations based on a predetermined threshold of the voltages, and to combine the final candidate locations to determine the location of the smartkey.
